(19) United States
(12) Patent Application Publication
(10) Pub. No.: US 2017/0357956 A1
(43) Pub. Date: Dec. 14, 2017

(54) METHODS AND SYSTEMS FOR PROCESSING A FUND TRANSFER

(71) Applicant: MASTERCARD INTERNATIONAL INCORPORATED, Purchase, NY (US)

(72) Inventor: Vijaykumar Vamanrao Borkar, Pune (IN)

(21) Appl. No.: 15/620,201

(22) Filed: Jun. 12, 2017

(30) Foreign Application Priority Data
Jun. 14, 2016 (SG) 10201604843V

(51) Int. Cl. G06Q 20/10; G06Q 20/40

(52) U.S. Cl. CPC G06Q 20/10; G06Q 20/405; G06Q 20/40145

(57) ABSTRACT

Computer-implemented methods and systems of processing a fund transfer from a payer to a payee via a payment network are disclosed. A payer's communication device is used to make a fund transfer request and send payee information to a payment network server. The payee information includes a photograph of the payee and a name of the payee's bank. The payment network server sends the photograph to a server of the payee's bank so that the payee's account information can be identified by interrogating an account database using the photograph. The fund transfer to the payee's account is then effected. Corresponding systems, devices and computer program products for carrying out the methods above are also provided.

### TECHNICAL FIELD AND BACKGROUND

The present disclosure relates to methods and systems for processing a fund transfer between a payer and a payee via a payment network. In particular, computerized-methods and systems are provided for processing person-to-person (P2P) payments.

There are existing methods for performing a person-to-person payment which allows individuals to send or receive money anytime via their smartphone or online. In particular, the sender (i.e. a payer) and recipient (i.e. a payee) uses downloadable mobile banking applications (Apps) to perform secure fund transfer transactions.

However, the existing methods leverages on online payment systems and are unable to support a fund transfer between the payer and payee if one of them do not have a smart device to set up or enroll in the service to accept an electronic payment.

Therefore, it is desirable to provide improved methods and systems for processing and making a fund transfer that alleviates the above problem.

### SUMMARY

In general terms, the present disclosure proposes a payer's communication device sending payee information which includes a payee's photograph to a payment network server to allow a payee's account held by the payee at a receiving institution to be identified, and thereby allowing a person-to-person payment to be effected over a payment network.

According to a first aspect, there is provided a computer-implemented method of processing a fund transfer from a payer to a payee. The method comprises a payment network server,

(a) obtaining funding authorization from a first server pursuant to a fund transfer request from a communication device, said first server being associated with a funding institution at which the payer holds a payer's account (e.g. for funding the fund transfer);
(b) receiving payee information from the communication device, said payee information comprising a photograph of the payee and a receiving institution at which the payee holds a payee's account (e.g. for receiving the fund);
(c) transmitting the photograph to a second server associated with the receiving institution to cause the payee's account to be identified using the photograph; and
(d) effecting said fund transfer to the payee's account upon successful funding authorization.

The above method may allow the essential information or communication required for the fund transfer to be provided and/or handled by the payer using a smart communication device of the payer. Accordingly, the intelligence of the transfer may be shifted to the payer to allow a payee to receive a person-to-person payment, even if the payee does not have a smart device or a dedicated service account set up to receive the payment.

Upon the payee's account being identified by the second server, an account number of the payee's account may be communicated to the payment network server such that the fund transfer may be effected (i.e. the fund is moved from the payer's account to the payee's account).

In some embodiments, upon the payee's account being identified by the second server, the second server may send a notification to the payment network server and to the payee via a payee's communication device. The payment network server may receive an authorization message from the payer's communication device before effecting said fund transfer.

In one embodiment, the notification may include a one-time-password (OTP). The OTP is communicated to the payer by the payee, e.g. verbally, or via a text message to the payer's communication device. The payer's communication device then sends the OTP as the authorization message to the payment network server to effect the fund transfer. For example, the payment network server may verify the OTP received from the payer's communication device against the OTP received from the payee's bank. The fund is transferred to the payee's account only when the verification is successful (e.g. the two OTPs match).

In another example when a plurality of candidate accounts are identified. A plurality of OTPs associated with respective candidate accounts may be sent to the communication device of the respective account holder. The payer is notified by the payee of the OTP corresponding to the intended payee's account and the payer's communication device sends the authorization message comprising the OTP to the payment network server. The verification is performed such that the fund is received by the account associated with the OTP encoded by the authorization message.

In one embodiment, additional information associated with the payee may be received by the payment network server which transmits the additional information to the second server (e.g. the payee's bank server) to cause the payee's account to be identified further using the additional information. The additional information may comprise biometric data of the payee.

According to a second aspect, there is provided a computer server for processing a fund transfer from a payer to a payee via a payment network, the computer server comprising a server processor, a data storage device storing server processor program instructions, the server processor program instructions being operative to cause the server processor to perform any one of the methods described above.

According to a third aspect, there is proposed a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

According to another aspect, there is provided a computer-implemented method of processing a fund transfer from a payer to a payee via a payment network. The method comprising a server:

(a) receiving a photograph of a payee from a payment network server pursuant to a fund transfer request;
(b) interrogating an account database using the photograph to identify a payee's account held by the payee at the financial institution; and
(c) receiving the fund by the payee's account via the payment network server.

The server is typically a server of a financial institution, such as a server of the payee's bank.

In one embodiment, the method may comprise, upon the payee's account being identified, the server transmitting a notification to a payment network server. Additionally or alternatively, the notification may be transmitted to a communication device of the payee, such as a payee's mobile phone. The notification may be sent to the payee's mobile phone via a SMS text message. The server may then receive an authorization message for the fund transfer, and receive the fund in response to the authorization message.

Typically, but not necessarily, the authorization message is received via the payment network server. The payment network may generate and send the authorization message, or it may be generated by a payer's communication device and communicated to the payee's bank server via the payment network server.

In one embodiment, the notification may comprise an account identifier associated with the payee's account. The account identifier may be generated by the payee's bank server in a form of a one-time-password (OTP). In other words, the account identifier may be dynamically generated and temporarily associated with the payee's account.

In some embodiments, there may be a plurality of candidate accounts identified using the photograph and a respective account identifier may be generated for each of the candidate accounts. The notification may comprise an account identifier associated with the respective candidate account. For example, a temporary identifier in a form of the OTP may be generated and respectively mapped to the candidate accounts. The OTP may be communicated to payer to indicate a selection of a correct or intended account while still preserving the confidentiality and security of the payee account information such as the account number.

In some embodiments, the plurality of candidate accounts are associated with a same account holder. For example, the payee may hold more than one account at the payee's bank. The notification which includes the respective associated plurality of account identifier may be generated and transmitted to a communication device of the account holder.

In some embodiments, the plurality of candidate accounts are associated with different account holders. For each account holder, a notification comprising one or more account identifiers associated with the respective one or more candidate accounts held by the account holder may be generated and transmitted to the account holder. In other words, a respective notification may be transmitted to a communication device of each respective account holder.

In one embodiment, the payee's bank server receives an authorization message which encodes an account identifier. This is verified against the account identifier of the payee's account. The fund is transferred to the payee's account if the verification is successful, for example, if the two account identifiers match. In another example, when there are a plurality of candidate accounts and associated account identifiers, the verification is performed such that the fund is received by an account which is associated with the account identifier encoded by the authorization message.

Typically, the account number of the payee's account is transmitted to the payment network server to effect the fund transfer to the payee's account.

In some embodiments, the method comprises interrogating the account database further using additional information associated with the payee. The additional information may be received via the payment network server. For example, the payee's bank server may request the additional information to be provided, such as via the payer's communication device. The additional information may comprise biometric data of the payee.

According to another aspect, there is provided a computer server (such as a server of a payee's bank) for processing a fund transfer from a payer to a payee via a payment network, the computer server comprising a server processor, a data storage device storing server processor program instructions, the server processor program instructions being operative to cause the server processor to perform any one of the methods described above.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

According to a further aspect, there is provided a computer-implemented method of making a fund transfer via a payment network. The method comprises a communication device (such as a payer's mobile phone):

(a) transmitting a fund transfer request to a payment network server to obtain funding authorization from a funding institution at which the payer holds a payer's account;
(b) obtaining payee information, said payee information comprising a photograph of a payee and a receiving institution at which the payee holds a payee's account; and
(c) transmitting the payee information to the payment network server to cause the payee's account to be identified using the photograph thereby enabling the payment network server to effect said fund transfer to the payee's account upon successful funding authorization.

The method may include capturing a photograph of the payee by a camera of the payer's mobile phone.

In one embodiment, the payee information may comprise additional information associated with the payee, such as biometric data of the payee. The additional information may be obtained from the payee in response to a request by the payment network server.

In some embodiments, the payer is notified upon the payee's account being identified, and in response the payer's communication device may transmit an authorization message to the payment network server, so that the payment network server is caused to effect said fund transfer. The authorization message comprises an account identifier associated with the payee's account.

According to a further aspect, there is provided a communication device, the communication comprising a processor and a data storage device storing program instructions operative to cause the processor to perform any one of the methods described above.

The present disclosure further proposes a software product, such as at a time when it is stored in a non-transitory form on a tangible data storage device. The data storage device may be within a communication device of a user, or it may be a database from which the communication device is able to download the software. In particular, there is proposed a program product comprising computer program instructions which is operative, when implemented by a processor of a communication device, to cause the processor to perform any one of the methods described above.

Generally, the payee or payer's account may be any type of account the payee or payer holds at the respective banks or other financial institutions. Non-limiting examples of such an account are a debit account, current account, saving account, or any account that is linked to a credit card, prepaid card, or debit card issued by the bank.

### BRIEF DESCRIPTION OF THE DRAWINGS

Embodiments of the present disclosures will now be described for the sake of non-limiting example only, with reference to the following drawings in which:

FIG. 1 shows schematically a computerized payment network which is suitable to perform a method which is an embodiment;

FIG. 2 is a flow diagram of a method according to an embodiment;

FIG. 3 is a flow diagram of certain operations of another embodiment;

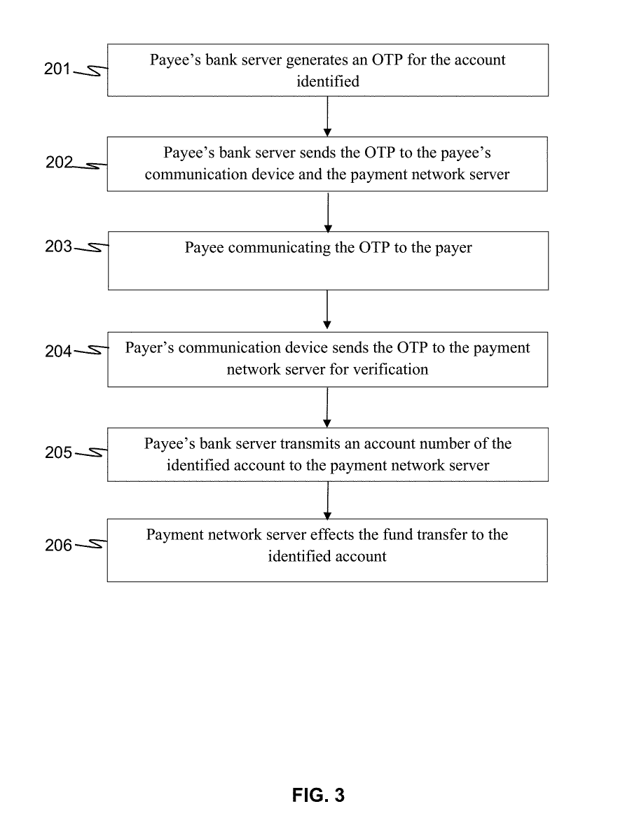

FIG. 4 is a flow diagram of certain operations of another embodiment;

FIG. 5 is a flow diagram of certain operations of another embodiment;

FIG. 6 is a flow diagram of certain operations of another embodiment;

FIG. 7 is a block diagram showing a technical architecture of a server suitable for implementing the present method; and

FIG. 8 is a block diagram showing a technical architecture of a communication device suitable for implementing the present method.

### DETAILED DESCRIPTION

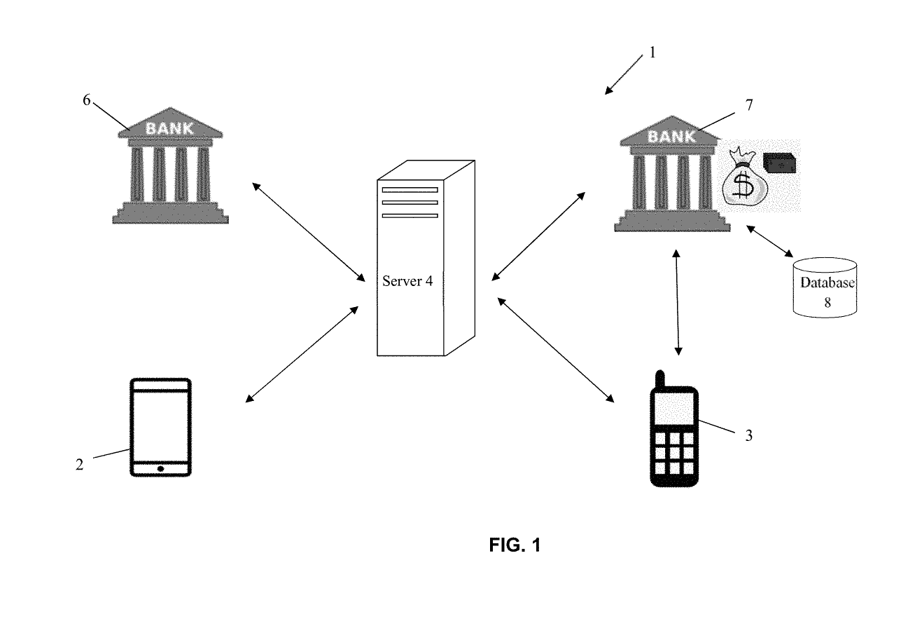

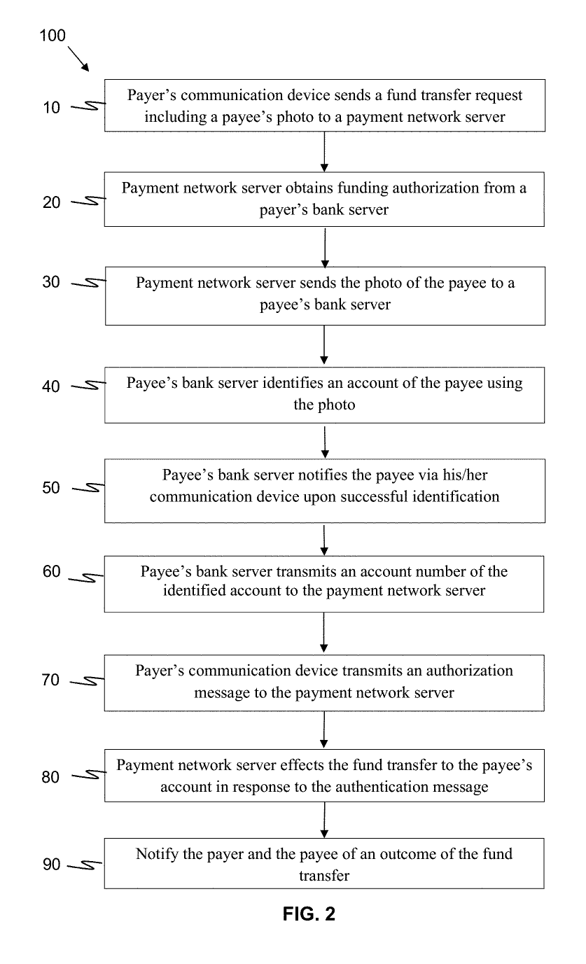

Referring to FIG. 1, a payment network is shown which is suitable for performing a method of an embodiment as illustrated by FIG. 2.

The payment network comprises a payment network server 4 for processing a fund transfer from a payer (i.e. the sender) to a payee (i.e. the recipient). The embodiments below will be illustrated with respect to a fund transfer between two accounts which are held by two human subjects. It will be understood that the method may apply to a fund transfer from a payer's account which is held by an organization (i.e. a non-human subject) to a payee's account which is held by a human subject, at respective financial institutions. In another possibility, the payee's account is held by the human subject on behalf of a legal entity, such as a merchant.

The payment network server 4 is configured to handle requests and/or communication from the various servers and devices associated with parties involved in a fund transfer over a payment network. The payment network server 4 is in communication with a server of a funding institution (e.g. a payer's bank server 6), a mobile phone 2 of the payer, a server of a receiving institution (e.g. a payee's bank server 7) and a mobile phone 3 of the payee. The various servers and devices may communicate with the server 4 via any types of network, for example, virtual private network (VPN), the Internet, a local area and/or wide area network (LAN and/or WAN), a wi-fi network, or a 3G or 4G telecommunication network. A non-limiting example of the payment network which offers money transfer service is the MasterCard Worldwide Network operated by MasterCard, Inc.

The payee's bank server 7 is in communication with an account database 8. The account database 8 stores a predefined association between account information of an account held by an account holder at the bank and personal information of the account holder. The account information may be an account number, an account type, or the like. The personal information of the account holder includes a photograph of the account holder. Ideally, the photograph allows the account holder to be uniquely identified among account holders of the bank. For example, the photograph may be a portrait of the account holder, in which his/her facial features are predominant. The person information may further comprise a name of the account holder, an address of the account holder, a personal identification number of the account holder or the like which allows the account holder to be identified, or identified within a context. According to a particular example, the personal information of the account holder also includes biometric data of the account holder such as retina or finger print data.

FIG. 2 illustrates a flow of an exemplary method 100 of the present disclosure. It should be noted that the embodiments below are described with references to the payer's and payee's mobile phones, but it will be appreciated by a skilled person in the art that other communication devices may be used such as a smart watch, a tablet computer or the like. For another example, in some embodiments, the payee's mobile phone 3 is a non-smart mobile phone which is accessible to traditional mobile telephony network, but not a cellular data network such as a 2G, 3G or 4G network. The mobile phone 3 may not have a network connectivity device which allows for network connection via wi-fi or Bluetooth hotspot.

It should also be noted that enumeration of operations is for purposes of clarity and that the operations need not be performed in the order implied by the enumeration.

In operation 10, a payer uses a camera of his mobile phone 2 to capture a photograph of a payee and obtains a payee's bank name at which the payee holds a payee's account for receiving the fund. Typically, the photograph contains complete and clear facial features of the account holder. The payer initiates a fund transfer request through a mobile application installed on the mobile phone 2. The fund transfer request is communicated to the payment network server 4 for processing the fund transfer. The fund transfer request encodes payer's payment information such as a name of the payer's bank, an address of the payer's bank, a branch name of the payer's bank, a payer's account, and a payment amount and/or a payment currency etc. The payee's photograph and the payee's bank name are also transmitted to the payment network server 4 with the fund transfer request.

In operation 20, the payment network server 4 obtains funding authorization from the payer's bank in response to the fund transfer request. This may be carried out in the form of a known process whereby the payment network server sends a query to a payer's bank server 7 to confirm that the payer's account has sufficient amount to fund the transaction, and optionally debits the amount from the account. The amount used to fund the transaction is typically the sum of the amount to be sent to the payee plus any fees charged by the payer's or payee's bank.

Upon funding authorization being successful, the payment network server 4 transmits the photograph to a server of the payee's bank at operation 30. In another possibility, the payment network server 4 receives the photograph of the payee from the mobile phone 2 after the funding authorization having been obtained successfully.

At operation 40, the payee's bank server 7 receives the photograph from the payment network server 4 and interrogates the account database 8 to identify the account holder and associated account using the photograph. For example, an image processing system employing facial recognition software may be used to process the photograph to extract features to identify potential matches using the personal information of the account holders in the account database 8.

At operation 50, the payee's bank server 7 send a notification to the payee's mobile phone 3 confirming that the payee's account has been successfully identified to receive the fund and transmits the account information of the payee's account to the payment network server 4. The account information may be an account number of the payee's account. The account information may also include an account type or other details of the payee's account.

The payee may communicate the confirmation to the payer such that an authorization message is sent to the payment network server 4 at operation 70. The payee may communicate the confirmation verbally to the payer in person, or by sending a text message to the payer's mobile phone 2.

At operation 80, the payment network server 4 receives the authorization message and effect the fund transfer (i.e. transfer the fund to the payee's account) accordingly. The payer and payee are notified of the outcome of the fund transfer via their mobile phones 2, 3 at operation 90.

As will be understood, the operation 20 does not need to be performed prior to operation 30. For example, in another embodiment, the operation 20 may be performed after operation 80.

In another embodiment, instead of performing operations 50-80 of the exemplary method 100, the payee's bank server 7 may send a notification to the payment network server 4 upon the payee's account being identified. For example, the notification simply informs the payment network server 4 that the payee's account has been successfully identified to receive the fund. The payee's bank server 7 may send account information of the identified account to the payment network server 4 for it to effect the fund transfer.

In another embodiment, operations 201-206 are performed in place of operations 50-80 of the method 100.

At operations 201-202, the payee's bank server 7 generates the notification in a form of a one-time-password (OTP), and sends the OTP to the payee's mobile phone 3, e.g. as an SMS text message. In this embodiment, the payee's bank server 7 also transmits the OTP to the payment network server 4.

At operation 203, the payee communicates the OTP to the payer. This may be performed verbally, or by the payee's mobile phone 3 sending a text message to the payer's mobile phone 2.

At operation 204, the payer sends an authorization message including the OTP using his mobile phone 2 to the payment network server 4. In other words, the payer authorizes the fund to be transferred to an account which is associated with a matching OTP. The payment network server 4 verifies the OTP received from the payer's mobile phone 2 against the OTP received from the payee's bank server 7.

At operation 205, the payee's bank server 7 transmits account information of the payee's account to the payment network server 4 upon successful verification. The account information may be an account number of the payee's account. The account information may also include an account type or other details of the payee's account. At operation 206, the fund transfer is effected (i.e. the fund is transferred to the payee's account) if the two OTPs are consistent.

In another possibility, the account information of the payee's account may be sent to the payment network server 4 before the verification is carried out by the payment network server 4, for example, together with the transmission of the OTP.

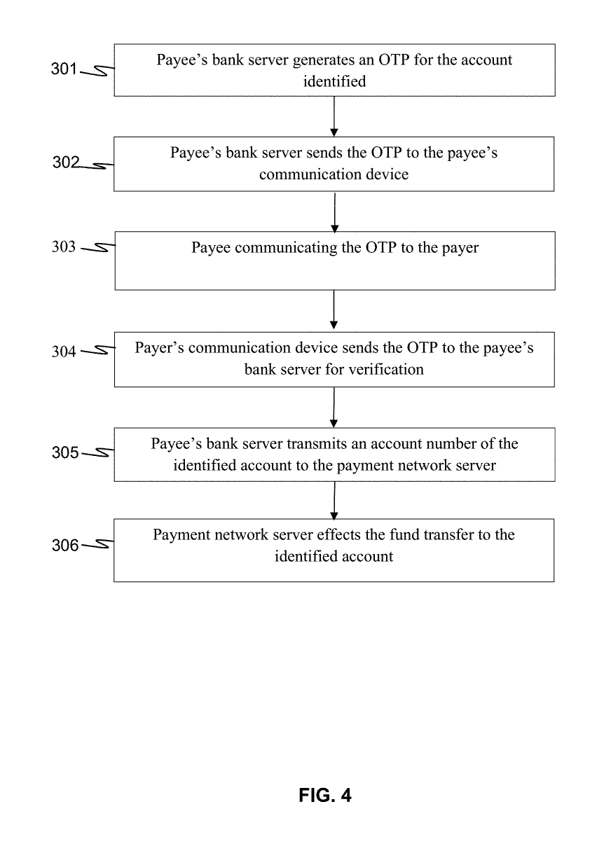

In another embodiment, the verification of OTP may be performed by the payee's bank server 7, instead of the payment network server 4, as illustrated by FIG. 4. Specifically, the payee's bank server 7 generates a one-time-password (OTP) at operations 301-302, and sends the OTP to the payee's mobile phone 3, e.g. as an SMS text message.

At operation 303, the payee communicates the OTP to the payer. Similarly, this may be performed verbally, or by the payee's mobile phone 3 sending a text message to the payer's mobile phone 2.

At operation 304, the payer sends the OTP to the payee's bank server 7 via the payment network server 4. The payee's bank server 7 uses the generated OTP to verify the OTP sent from the payer's mobile phone 2 to confirm the payee's account.

At operation 305, the payee's bank server 7 transmits account information of the payee's account to the payment network server 4 upon successful verification. Similarly, the account information may be an account number of the payee's account. The account information may also include an account type or other details of the payee's account. At operation 306, the fund transfer is effected accordingly.

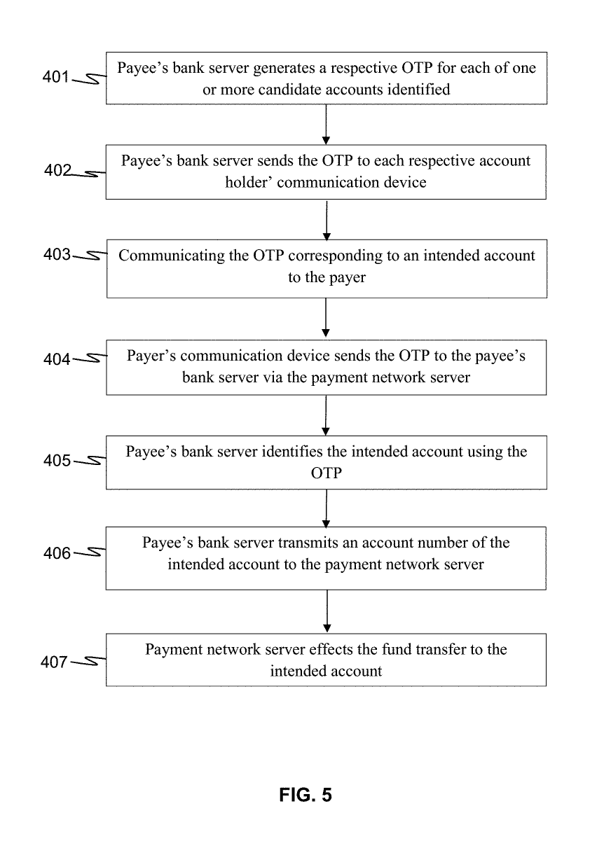

In another embodiment, the payee's bank server 7 may identify a plurality of candidate accounts using the photograph. If there are more than one accounts which are determined to be potentially associated with the photograph, operations 401-407 may be performed to uniquely identify and verify a payee's account to receive the fund, as illustrated by FIG. 5.

At operation 401, the payee's bank server 7 generates a respective account identifier for each candidate account. In this example, the account identifier is in a form of an OTP, and the OTP is sent to an account holder of the associated account at operation 402. For example, the OTP may be sent to a registered mobile phone number of the account holder.

If the candidate accounts are associated with a same account holder (e.g. when the payee holds more than one account at the bank), a notification which includes the OTPs and names of the corresponding accounts is transmitted to the payee's mobile phone 3. At operation 403, the payee informs the payer of the OTP corresponding to the account that he intends to use for receiving the fund. At operation 404, the payer sends the OTP to the payee's bank server 7 for the intended account to be identified, and verified by the payee's bank at operation 405. For example, the verification may be performed by the payee's bank server 7 identifying the account that corresponds to the OTP. At operation 406, the payee's bank server 7 transmits an account number to the payment network server 4 for it to effect the fund transfer to the identified account at operation 407.

In some embodiments, if the candidate accounts are associated with different account holders, OTPs are sent to the respective account holders of the associated account. In a particular example, for each account holder, an OTP (or OTPs, if the account holder has more than one account) is generated for the account, and sent to a registered mobile number of the account holder. The intended payee, who has received an OTP from the bank, informs the payer of the OTP (or one of the OTPs which corresponds to the account he intends to use for receiving the fund). Similarly, the payer sends the OTP to the payee's bank server 7 for the intended account to be identified, and verified by the payee's bank, as described in the earlier embodiments.

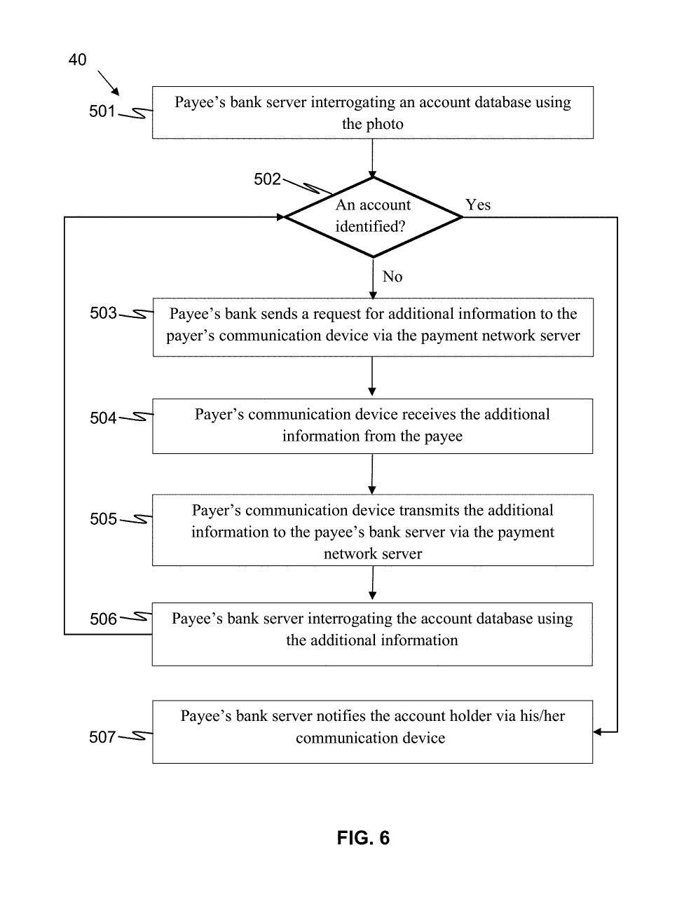

In another embodiment, operation 40 of the method 100 may comprise sub-operations 501-507 as illustrated by FIG. 6.

At operation 501, the payee's bank server 7 runs the received photograph through the account database 8 to search for an account corresponding to the photograph.

At operation 502, if an account has been successfully identified, the payee's bank server 7 notifies the account holder via his mobile 3. If not, operation 503 is performed to request for additional information associated with the payee. The payee's banks server 7 notifies the payer via the payment network server 4 to supply the additional information. In one example, the additional information includes a name or a full name of the payee, address of the payee, an account type, a personal identification number of the payee or biometric data of the payee such as his retina or finger print data. The additional information can be received by the payer's mobile 2 at operation 504, which is sent to the payee's bank server 7 via the payment network server 4 at operation 505. At operation 506, the payee's bank server 7 interrogates the account database 8 using the additional information to identify the payee's account. If unsuccessful, sub-operations 503-506 may be repeated using further additional information until an account is successfully identified.

In another embodiment, if the payee's bank server 7 identifies more than one candidate accounts at operation 40, sub-operations 501-507 as described above may be performed as an alternative to or in addition to sub-operations 401-407 to allow the payee's account to be identified uniquely further using the additional information associated with the payee.

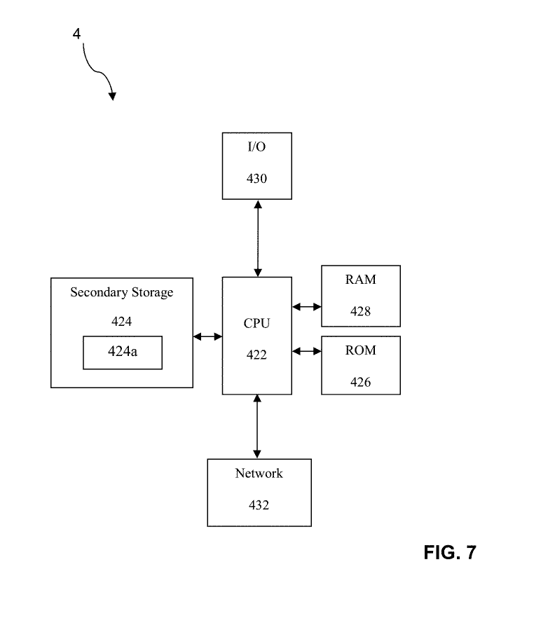

FIG. 7 is a block diagram showing a technical architecture of a server (e.g. the payment network server 4, the payer's bank server 6 or the payee's bank server 7) suitable for implementing the present method.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

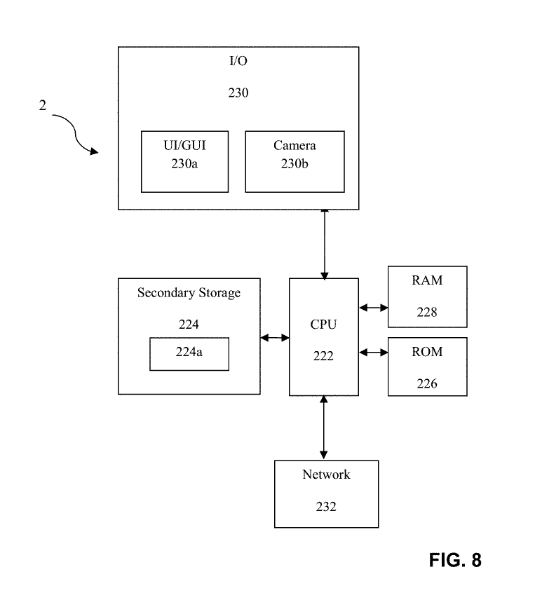

FIG. 8 is a block diagram showing a technical architecture of a communication device (e.g. the payer's or payee's communication device 2, 3). The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230a and the camera 230b.

The UI 230a may comprise a screen in the form of a touch screen, a keyboard, a keypad or other known input device.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention. For example, the photograph of the payee may be obtained by the payer's mobile phone by retrieving the photograph from a memory component of the communication device. For another example, the photograph may be received from another device via a communication network, such as from another communication device, or from a cloud server which is remote to the communication device.

1. A computer-implemented method of processing a fund transfer from a payer to a payee, the method comprising a payment network server,
(a) obtaining funding authorization from a first server pursuant to a fund transfer request from a communication device, said first server being associated with a funding institution at which the payer holds a payer's account;
(b) receiving payee information from the communication device, said payee information comprising a photograph of the payee and a receiving institution at which the payee holds a payee's account;
(c) transmitting the photograph to a second server associated with the receiving institution to cause the payee's account to be identified using the photograph; and
(d) effecting said fund transfer to the payee's account upon successful funding authorization.

2. The method according to claim 1 further comprising receiving additional information associated with the payee and transmitting the additional information to the second server to cause the payee's account to be identified further using the additional information.

3. The method according to claim 2, wherein the additional information comprises biometric data of the payee.

4. The method according to claim 2 further comprising receiving a notification from the second server in response to the payee's account being identified, obtaining an authorization message for the fund transfer from the communication device, and effecting said fund transfer in response to the authorization message.

5. The method according to claim 4, wherein the notification comprises an account identifier associated with the payee's account, the method further comprising verifying the authorization message using the account identifier, and effecting the fund transfer to the payee's account upon successful verification.

6. The method according to claim 1 further comprising receiving an account number of the payee's account from the second server.

7. A computer server for processing a fund transfer from a payer to a payee via a payment network, the computer server comprising a server processor, a data storage device storing server processor program instructions, the server processor program instructions being operative to cause the server processor to:
(a) obtain funding authorization from a first server pursuant to a fund transfer request from a communication device, said first server being associated with a funding institution at which the payer holds a payer's account;
(b) receive payee information from the communication device, said payee information comprising a photograph of the payee and a receiving institution at which the payee holds a payee's account;
(c) transmit the photograph to a second server associated with the receiving institution to cause the payee's account to be identified using the photograph; and
(d) effect said fund transfer to the payee's account upon successful funding authorization.

8. The computer server according to claim 7, wherein the data storage device stores server processor program instructions operative to cause the server processor to receive additional information associated with the payee and transmit the additional information to the second server to cause the payee's account to be identified further using the additional information.

9. The computer server according to claim 8, wherein the data storage device stores server processor program instructions operative to cause the server processor to receive a notification from the second server in response to the payee's account being identified, obtain an authorization message for the fund transfer from the communication device, and effect said fund transfer in response to the authorization message.

10. The computer server according to claim 7, wherein the data storage device stores server processor program instructions operative to cause the server processor to receive an account number of the payee's account from the second server.

11. A computer program product comprising server computer program instructions, the computer program instructions being operative, when implemented by a server processor to cause the server processor to perform a method of claim 1.

12. A computer-implemented method of making a fund transfer via a payment network, the method comprising a communication device:
(a) transmitting a fund transfer request to a payment network server to obtain funding authorization from a funding institution at which the payer holds a payer's account;
(b) obtaining payee information, said payee information comprising a photograph of a payee and a receiving institution at which the payee holds a payee's account; and
(c) transmitting the payee information to the payment network server to cause the payee's account to be identified using the photograph thereby enabling the payment network server to effect said fund transfer to the payee's account upon successful funding authorization.

13. The method according to claim 12, wherein operation (b) comprises capturing a photograph of the payee by a camera of the communication device.

14. The method according to claim 12, wherein the payee information comprises additional information associated with the payee.

15. The method according to claim 14 comprising transmitting the additional information in response to a request by the payment network server.

16. The method according claim 14, wherein the additional information comprises biometric data of the payee.

17. The method according to claim 12 further comprising transmitting an authorization message to the payment network server in response to the payee's account being identified thereby causing the payment network server to effect said fund transfer in response to the authorization message.

18. The method according to claim 17, wherein the authorization message comprises an account identifier associated with the payee's account.

19. A communication device, the communication comprising a processor and a data storage device storing program instructions,
the program instructions being operative, to cause the processor to:
(a) transmit a fund transfer request to a payment network server to obtain funding authorization from a funding institution at which the payer holds a payer's account;
(b) obtain payee information, said payee information comprising a photograph of a payee and a receiving institution at which the payee holds a payee's account; and
(c) transmit the payee information to the payment network server to cause the payee's account to be identified using the photograph thereby enabling the payment network server to effect said fund transfer to the payee's account upon successful funding authorization.

20. The communication device according to claim 19, wherein the data storage device stores program instructions operative to cause the processor to perform operation (b) by capturing a photograph of the payee by a camera of the communication device.

21. The communication device according to claim 19, wherein the data storage device stores program instructions operative to cause the processor to obtain additional information associated with the payee and transmitting the additional information in response to a request by the payment network server.

22. The communication device according to claim 19, wherein the data storage device stores program instructions operative to cause the processor to transmit an authorization message to the payment network server in response to the payee's account being identified to cause the payment network server to effect said fund transfer in response to the authorization message.

23. A computer program product comprising computer program instructions, the computer program instructions being operative, when implemented by a processor to cause the server processor to perform a method of claim 12.
